(19) United States
(12) Patent Application Publication
(10) Pub. No.: US 2006/0026261 A1
(43) Pub. Date: Feb. 2, 2006

(54) Apparatus for and a method of facilitating the carrying out of a task

(75) Inventors: Peter Michael Allday, Bracknell (GB); Georgios Vasilopoulos, London (GB); Andrew Millin, London (GB); Wilson Sien Chun Chiu, Bracknell (GB)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/191,043

(22) Filed: Jul. 28, 2005

(30) Foreign Application Priority Data
Jul. 30, 2004 (GB) 0417101.3

(51) Int. Cl. G06F 15/16

(52) U.S. Cl. 709/217

(57) ABSTRACT

In a network system, a client device is connected to the network via a controller that enables a user of the client device to carry out a task using one or more services available on the network.

The controller (10) has a service discoverer (12) that discovers services at locations on the network (N) and a task manager (14) that controls the carrying out of tasks using services discovered by the service discoverer (12). The controller (10) also has a service publisher (13) that, as a result of the discovery of a service by the service discoverer (12) makes that service discoverable by other controllers (10) connected to the network, thereby allowing those other controllers to discover and access that service or services via that controller.

This invention relates to apparatus for and a method of facilitating the carrying out of a task. In particular, this invention relates to apparatus for and a method of facilitating the carrying out of a task by a processor-controlled machine in a distributed system or network in which a number of processor-controlled machines such as personal computers, servers, digital cameras, photocopiers and the like have or have access to services that may be required for the carrying out of a task.

In order to complete a complex task on a network, a user may have to make use of several different applications to perform different operations. Thus, for example, if a user wishes to email a copy of a paper document so that the recipient can subsequently edit the document using a word processing application, then, generally, the user will need to use a scanner application to convert the paper document into electronic form, then use an optical character recognition application to convert the electronic data into electronic character data and then use an emailing application to email the final electronic document to the desired recipient.

A task-based approach to such complex operations simplifies the number of individual operations that a user has to perform. In a task-based approach, a controller forming part of the network (for example a server with which the user's processor-controlled machine can communicate or the user's processor-controlled machine itself) identifies the task to be carried out from data provided by the user and then either selects a predefined task consisting of the required services or assembles a new task consisting of the required services. Thereafter, the user simply needs to provide user input data when prompted by the controller to enable the carrying out of the task.

Thus, in the example given above, where the user advises the controller that he wishes to email a hard copy document in editable form, then the controller will either access a predetermined task for carrying out that sequence of steps or will assemble a new task to carry out that predetermined sequence of steps. In either case, the task in this example will consist of a set of services including a scanning service, an optical character recognition service and an emailing service.

The number of tasks that can be carried out is limited by the services that the controller can access and, although a controller may be able to access services remotely over the network, it is difficult if not impossible for a controller to access services that are only coupled to the network via other controllers.

In one aspect, the present invention provides a controller or apparatus for enabling the carrying out of task, wherein the apparatus is connectable to a network and comprises a service discover operable to discover services over the network, a task manager operable to control the carrying out of tasks using services accessible by the apparatus and a service publisher for publishing descriptions of services accessible to or discovered by the apparatus so that other controllers coupled to the network can see the services published by the controller even though at least some of those services may be connected to the network only via the controller.

In one aspect, the present invention provides a controller for facilitating a carrying out of a task, wherein the controller is connectable to a network and looks to other controllers like a service thereby allowing other controllers to discover and access the services via that controller.

This enables a controller to access services that it may not be able to see directly and as a result allows more or more flexible tasks to be offered to the user.

In an embodiment, a controller is configured to enable the list of services that are passed on to another controller to be subject to security restrictions. For example, the controller may be configured to restrict the list of services that are passed on to another controller on the basis of the identity of the user that is trying to access them and/or on security restrictions that are placed on the service by the at least one controller in the route from the location of actual service to the requesting controller.

A controller may be configured to provide different security restrictions dependent upon whether the user is local to the controller or whether a service is being requested by a remote controller.

A controller may be configured to increment a hop count each time a description of a service is passed to that controller so that, for example, where a controller receives the same service description more than once, the controller can determine the most direct route to the actual location of that service.

A controller may be configured to add descriptions of services that have been discovered more than once to a cache so that, if a route to a particular service fails, then that same service may be tried again via a different route.

In an embodiment, the services available for the carrying out of a task will generally include input services, output services, and processing services. In addition, the available services may include user interface services. This avoids the possibility of the services available to a user being restricted by the user interface of the device via which the user accesses the controller. Rather, by providing the user interfaces as services, then the user interface required by a task or indeed user interfaces required by different services within a task can be loaded on to the user's device as and when required so that dedicated user interfaces can be provided for different services within a task. This has the advantage that the user interface presented to the user is not cluttered with information which is particularly important where the size of the display on the user's device is relatively small. In addition, providing the user interfaces as services enables user interfaces for existing services and tasks to be updated as and when required.

Different protocols may be required for discovering different services. In an embodiment, the services use a common API (application programming interface) and the service discoverer is configured with a plug-in architecture so that the service discoverer has one or more plug-in service discovery modules, each of which is designed to discover services that use a particular protocol or protocols. For example, one service discovery plug-in module may be designed to discover Web services, another service discovery plug-in module may be designed to discover JINI services and another service discovery plug-in module may be designed to discover local services, that is services directly connected to the controller. The use of a plug-in architecture means that a controller can be upgraded or updated when new protocols come into use simply by adding a plug-in configured to operate with that protocol. Thus, when a new protocol becomes popular, it can easily be supported and deployed without changing the rest of the controller. In addition, controllers of smaller devices (such as digital cameras) can just use the plug-in or plug-ins that they require. The use of such plug-ins and a common API for services means that a service which uses a protocol for which a plug-in has already been developed can be used straight away without any further adaptation and, if a new protocol is developed or used, then only one plug-in needs to be developed to handle services using that protocol.

In a task based system, some services may require certain parameters to be set by a user. However, a user may not always know the best value for a parameter. Therefore, it is often desirable for a default parameter to be set.

In an embodiment, default parameters are provided on different levels. Thus, a service may itself have a default parameter and this default parameter may be overridden by a default task parameter, so that when a particular service is running in a particular task, the default parameter is appropriate to that task. Thus, for example, a scanning service may have its own default scanning resolution parameter which, for example, represents an average resolution while a task to scan and email a photograph may have a different resolution default parameter that overrides the service default parameter so that, when scanning a photograph for emailing, the scanner scans at a relatively low resolution to reduce the size of the image file while where the scanning services is used in a task in which a document is to be subject to optical character recognition, for example the above task to scan and email in editable form a hard copy document, then the task may define a high resolution default scanning parameter to enable accurate optical character recognition. In addition, a user interface service may enable a user to change or customize the service level default parameter or the task level default parameter in accordance with their requirements.

The device at which a user commences a task may not necessarily be the best device to enable completion of the entire task. Thus, for example, in the case of the above task to scan and email in editable form a hard copy document, the user may wish to use a networked photocopier to perform the scanning but then move to a personal computer to enable access to a keyboard to enter information. In addition, some services may require more processing power than other services and it may speed up completion of a task if a high processing power service is completed by a device having a lot of processing capacity, for example it may be more efficient for a particular service to be carried out by a networked personal computer rather than a networked digital camera.

In an embodiment, a task is designed so that it can be stored in an incomplete form and transfer to another, for example more powerful, controller to enable completion of the next portion of the task. In an embodiment, the current state of a task and the data associated with it is stored in a data structure known as a context, for example an XML based context, which can be passed between controllers allowing a user to access the task from different client devices. This means that a user can commence a task at one client device and move to another that may be more suitable for continuation of the task with, in each case, the controller controlling the coordination and processing of the task so as to enable the task state to be stored for later retrieval or passed to another controller for continued processing.

Embodiments of the present invention will now be described, by way of example, with reference to the accompanying drawings, in which:

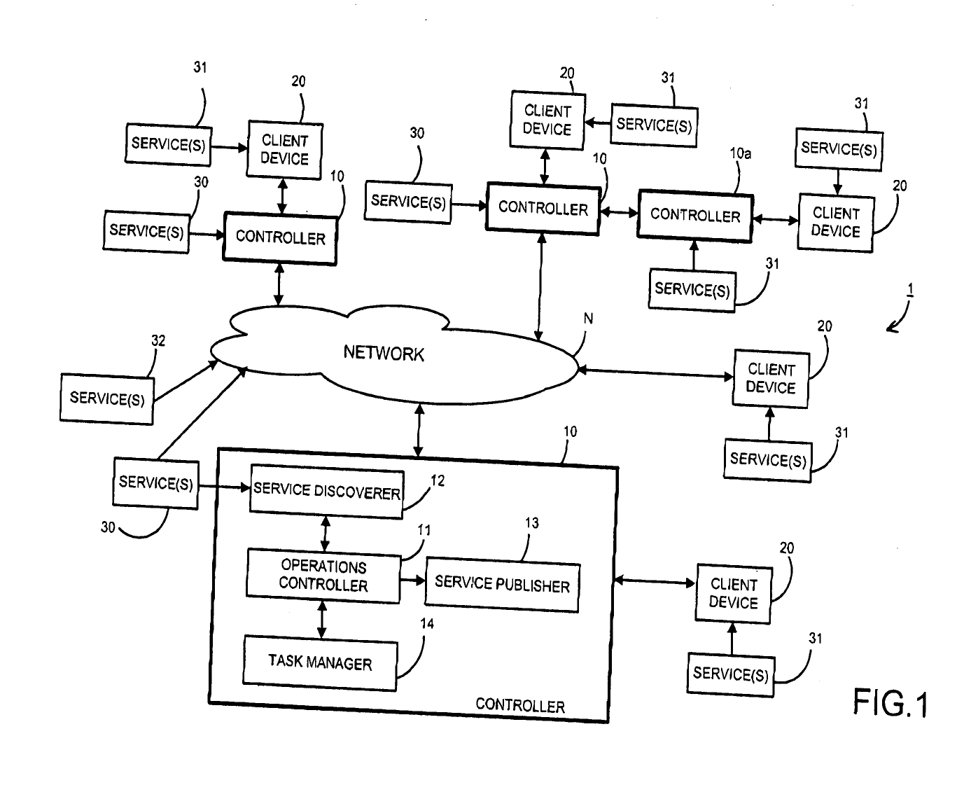

FIG. 1 shows a functional block diagram of a network system including a controller embodying the present invention for facilitating the carrying out of a task;

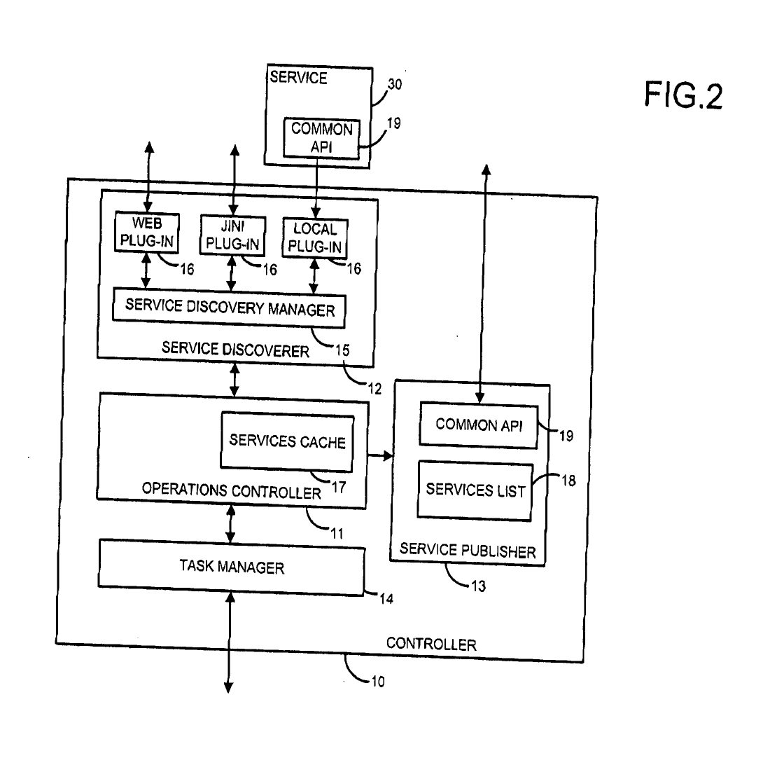

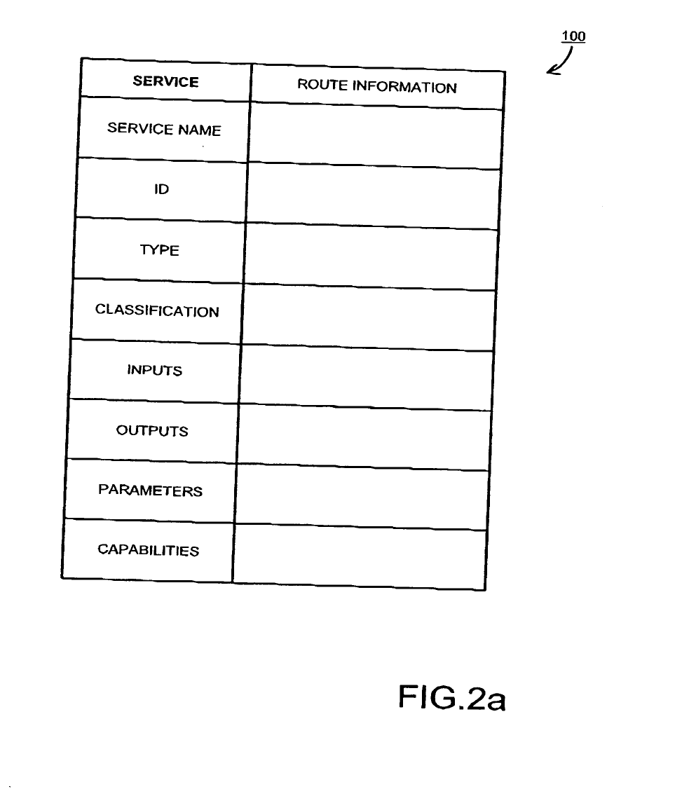

FIG. 2 shows a more detailed functional block diagram of a controller embodying the present invention;

FIG. 2a shows a very diagrammatic representation of a service description;

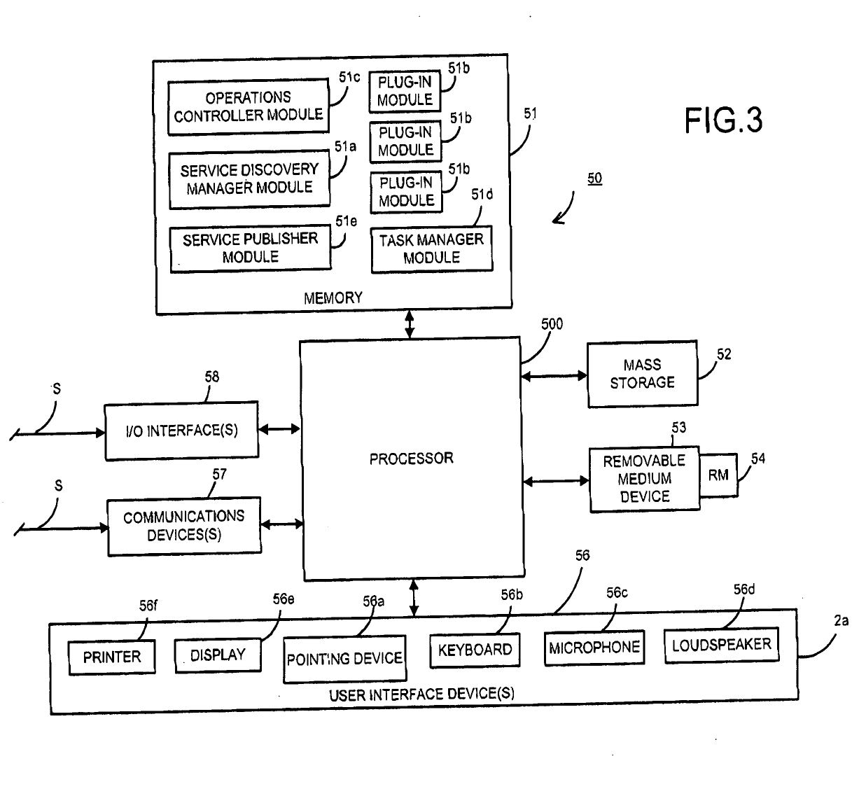

FIG. 3 shows a functional block diagram of one example of computing apparatus configured to provide the controller shown in FIGS. 1 and 2;

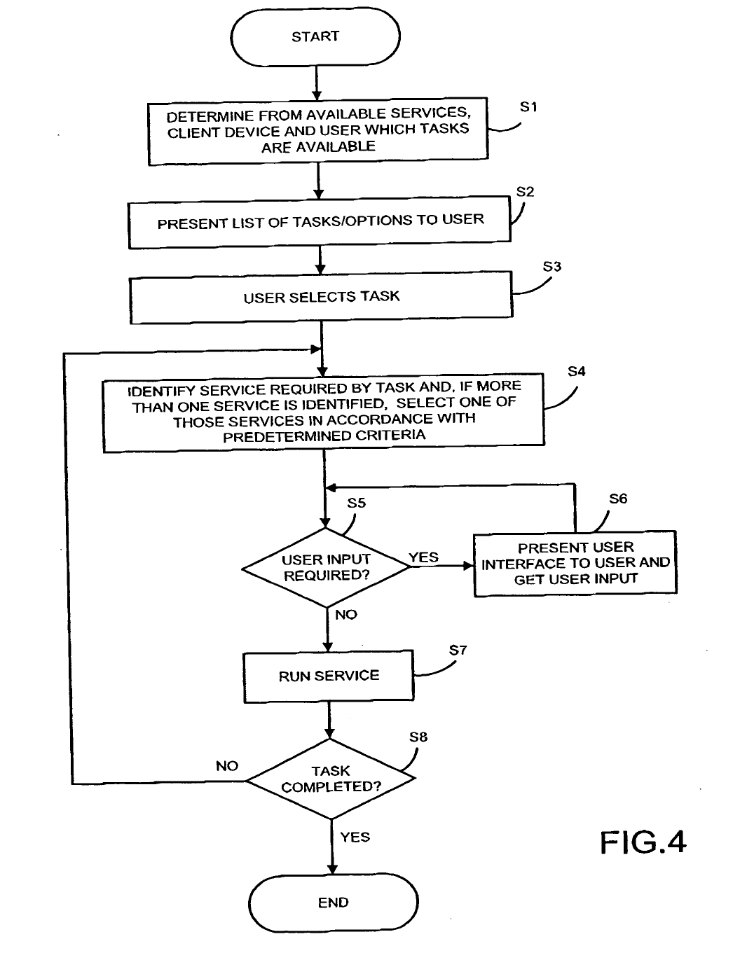

FIG. 4 shows a flowchart for illustrating one way in which a task manager of the controller shown in FIGS. 1 and 2 can manage the carrying out of a task;

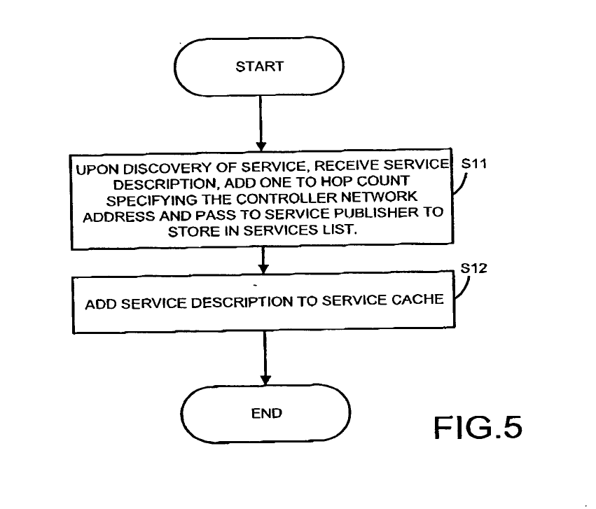

FIG. 5 shows a flowchart for illustrating operation of the controller to discover a new service;

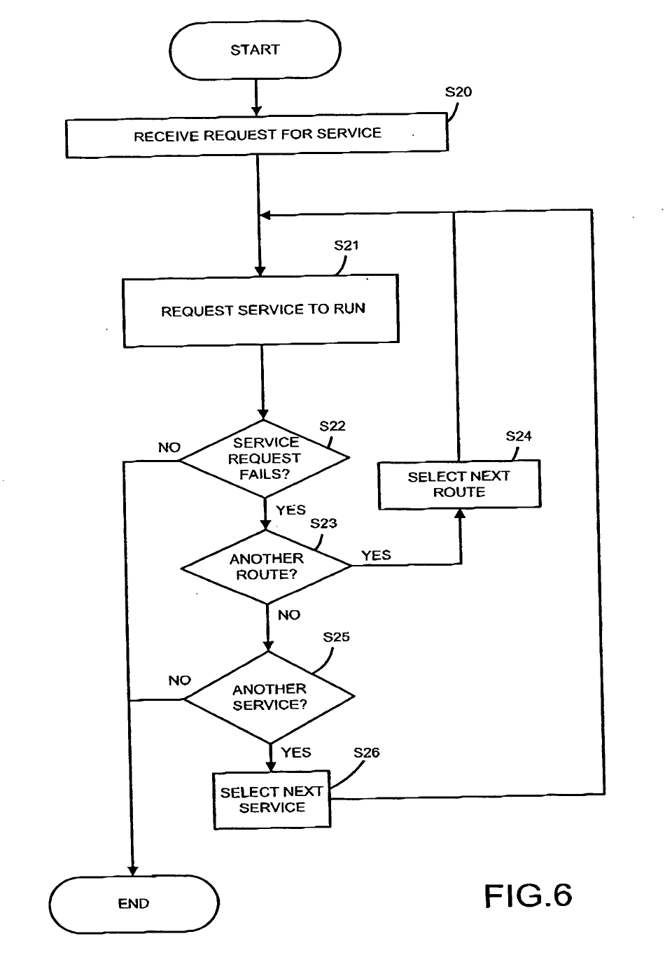

FIG. 6 shows a flowchart for illustrating operation of the controller to access a service,

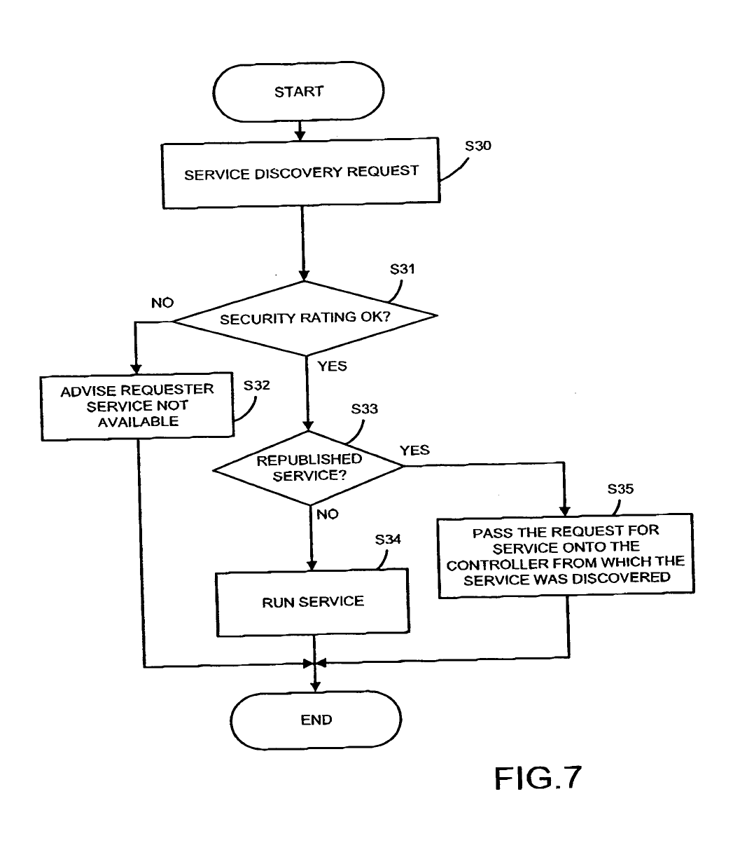

FIG. 7 shows a flowchart for illustrating operation of the controller in response to a request for a service; and

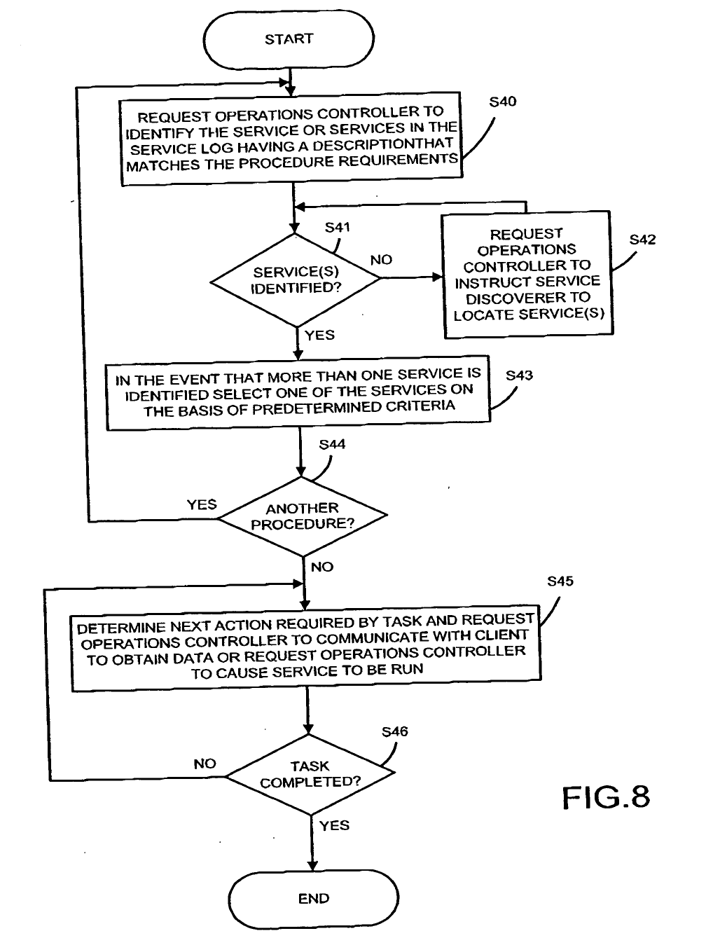

FIG. 8 shows a flowchart illustrating another way in which the task manager can manage the carrying out of a task.

Referring now to the drawings, FIG. 1 shows a functional block diagram of a network system 1 embodying the invention.

The network system 1 comprises a number of controllers 10 in the form of personal computers, servers, other processor device or the like each connected to one or more client devices 20 by which a user can input instructions and/or data for instructing the controller to carry out a task using services accessible by the controller. As shown in FIG. 1, a controller 10 may have local services 30. In addition, services 32 may be directly connected to the network N and services 31 may be directly connected to a client device 20.

The controllers 10 may be directly coupled to the network N or via one or more other controllers 10. In the example shown in FIG. 1, three controllers 10 are directly coupled to the network and a further controller 10a is indirectly coupled to the network via another one of the controllers. It will, of course, be appreciated that the actual network configuration will depend upon the particular circumstances and that, for example, fewer or more than three controllers may be directly coupled to the network Also, the network may comprise further controllers 10a that are only coupled to the network indirectly via another controller. In addition, the network system may also include further controllers that are coupled to the network via two or more other controllers.

Although not shown in FIG. 1, each client device 20 may incorporate or be integrated with a controller 10. In addition, a client device 20 may communicate with a controller 10 via the network N.

The client devices 20 are processor-controlled machines provided with network connectivity and each having at least one user interface device for enabling a user to interface with the client device. Examples of client devices are networkable devices such as personal computers, photocopiers, facsimile machines, digital cameras, scanners and other items of office equipment where the network is intended for use in an office environment.

It will, of course, be appreciated that the network may be intended for use in other than an office environment. Thus, for example, where the network is in a home environment, then the client devices may include personal computers and other networkable processor-controlled machines such as, for example, televisions, video recorders, DVD players, and other processor-controlled machines or items of equipment that may be found within the home. Similarly, the network system may be used in an industrial environment where one or more of the client devices may comprise processor-controlled manufacturing plant or machine tools.

The network N may comprise one or more different types of network. For example, the network N may comprise at least one of a local area network 11 (LAN), a wide area network (WAN), an intranet and the Internet.

FIG. 1 illustrates the main functional components of one of the controllers 10. It will be appreciated that each of the other controllers 10 and 10a has the same main functional components.

As shown in FIG. 1, a controller 10 has an operations controller 11 that controls overall operation of the controller and a task manager or task resolution module 14 for controlling or managing the carrying out of tasks. In addition, each controller 10 has a service discoverer 12 for discovering both local services 30 and services on the network N and a service publisher 13 that, as will be described below, is configured to make services discovered by the controller 10 discoverable by other controllers 10. That is, the service publisher 13 is configured to advertise or republish discovered services so that they are accessible by other controllers 10 over the network N.

The operations controller 11 is also configured to communicate with the client device or devices 20 connected to the controller 10 and to communicate with the services required during the carrying out of a task and to coordinate the operation of the next step in a task as requested by the task manager 14. In addition the operations controller 11 is configured to pass on calls made to services published by the service publisher 13, that is services that are not directly available to that controller 10.

The task manager 14 is configured to determine which task(s) can be run using the currently available client device(s) 20 and services and to determine the next action required, for example whether data is required from a user or whether a service should be run.

The task manager 14 is, in this embodiment, configured as a separate module so that it can be swapped in and out easily so that a controller 10 has a task manager that is appropriate to the client device 20, and to enable easy modification of the system.

As mentioned above, each of the controllers 10 may have access to a number of local services 30. In addition, each of the client devices 20 may have direct access to one or more services 31 and one or more services 32 may be directly coupled to the network N to enable access by all of the controllers 10.

The services 30, 31 and 32 are stored in appropriate memory. The services 30 may be stored in a central data storage of the network system 1 while the services 30 and 31 may be stored in any appropriate memory available at the controller 10 or client device 20, for example a mass storage device such as a hard disc drive in the case of a computer, or on a memory card in the case of a client device such as a digital camera.

Generally speaking in this embodiment there are four types of services
1) input services that provide input data to a task, an example being a scanning service;
2) output services that output data from a task such as, for example, printing services and email services;
3) processing services that perform a process on or modify input data such as, for example, image manipulation services, optical character recognition services and so on; and
4) user interface services that provide user interfaces for loading onto client devices.

A service may itself consist of a set of sub-services so that, for example, an address book service may consist of the sub-services “open address book” and “save address book” plus also possibly an address book user interface sub-service.

Each service uses the same common API (Application Programming Interface) which implements four methods:

1. Get description

2. Get status

3. Run service

4. Get user interface(s)

The common API therefore enables a controller 10 to discover services and to obtain their description and status and, when the task manager 14 indicates that a service is required, to get the associated user interface or interfaces and to run the service.

FIG. 2a shows a very diagrammatic representation 100 of a service description.

The service description includes the following components.

1. Service name

2 ID

3. Type

4. Inputs

5. Outputs

6. Parameters

7. Capabilities

The service description optionally also includes a classification component.

The service name is unique to the service so that if, for example, there is more than one controller 10 or client device 20 on the network N that runs the same service, they will be allocated the same service name while the ID is unique to the particular service and controller or client device that actually runs that service and may be in the form of a serial number or other unique code.

The type component defines the typo of service and is descriptive of the operation or procedure that the service performs such as scan, email, OCR, print, image manipulation, and so on.

The optional classification component represents a lower level description of the service and identifies features available via that service. Thus, for example, in a case of a service of the type “image manipulation”, the classification will specify the particular nature of the image manipulation provided by the service, examples of possible classifications for an image manipulation service are: re-size, red eye removal, rotate, make panorama and so on.

The input component defines the type or types of data that can be passed to the service and the format or formats required for that data while the output component defines the data type or types that the service provides and the format or formats that that output data has.

The parameter component comprises a value or values that can be passed to the service and that affect(s) what the service does with data. The service description may contain a default value for one or more parameters. An example of a parameter for a print service would be, for example, a value for the number of copies.

The capability component provides a description of what the service is capable of Thus, for example, the capability component may define the maximum resolution in dots per inch of a scanning or printing service.

Each input, output and parameter has an ID that describes the nature of the data (for example image or document), a type which identifies the family that the data belongs to and a format that identifies the exact format that the data takes. Thus, for example, if the type is “MIME” then the format may be image/png or application/word whereas if the type is “simple” then the format may be “string ” or “int”.

In addition, inputs, outputs and parameters may specify a constraint or limit on those properties, for a maximum size of input data or a maximum or minimum resolution may be specified.

The service description thus provides a controller 10 with the information necessary to determine whether the service is suitable for and can carry out an operation required for a particular task.

FIG. 2 shows a more detailed functional block diagram of one example of a controller 10.

As shown in FIG. 2, the service discoverer 12 comprises a service discovery manager 15 configured to receive a number of plug-ins 16 (three in the example shown), Each of the plug-ins 16 is configured to enable discovery of services operating in accordance with certain protocols. The plug-ins 16 may comprise, as shown, a plug-in configured to discover Web services, for example operating in accordance with the UDDI (Universal Description Discovery and Integration) protocol and the SOAP (Simple Object Access Protocol) communications protocol, a plug-in configured to discover JINI services and a plug-in configured to discover local services. FIG. 2 shows the local plug-in 16 having discovered a local service 30. The fact that the services use or implement a common API is illustrated diagrammatically in FIG. 2 by using a block 19 to represent the common API.

The use of a plug-in architecture means that, as new discovery systems and protocols are developed, new plug-ins 16 can be designed to enable discovery of services using those protocols. In addition, a controller 10 need only use those plug-ins required by the client(s) 20 with which it communicates. Thus, for example, if a controller 10 is only communicating with a dedicated processor-controlled machine such as a digital camera, then only those plug-ins commensurate with the services that a digital camera can use may be provided.

In addition to the plug-in architecture, the services useable by the network system are all configured to use the same common API. The use of a common API enables a new service to be used straight away, provided that a plug-in exists for the protocol(s) required by that service.

As shown in FIG. 2, the operations controller 11 maintains a services cache 17 in which the service descriptions of discovered services are held. In addition, the service publisher 13 stores a services list 18 containing the service descriptions of all of the services that have been discovered by the controller 10. The service publisher 13 is also configured to communicate with the network N and the directly connected client device(s) 20 using the common API (again represented diagrammatically by a block 19) go that the other controllers 10 on the network N and the connected client device(s) 20 can see the controller as a service.

The controllers 10 may be implemented by programming computing apparatus such as a personal computer or server or other processor device. FIG. 3 shows a functional block diagram of one example of computing apparatus 50 that may be programmed by program instructions to provide a controller 10.

As shown in FIG. 3, the computing apparatus 50 comprises a processor 500 with associated memory 51 in the form of ROM and/or RAM and a mass storage device 52 such as a hard disk drive. The computing apparatus also comprises a removable medium device 53 for receiving a removable medium 54 such as, for example, a CDROM, DVD, floppy disk or the like. In addition, the computing apparatus comprises a number of user interface devices 56. As shown these include a pointing device 56a such as a mouse, a keyboard 56b, a microphone 56c, a loudspeaker 56d, a display 56e and a printer 56f. The computing apparatus also comprises one or more communications devices 57 such as a network card and/or a MODEM for enabling communication over the network N and one or more input/output interface(s) 58 for enabling communication with external devices such as the client device 20 and the services 30 directly linked to the controller 10.

The computing apparatus is programmed by at least one of:

program instructions pre-stored in the memory 51 or in the mass storage device 52;

program instructions provided as a signal via a communications device 57 or an I/O interface 58.

program instructions downloaded from a removable medium 54 received via the removable medium device 53 or from a portable data storage device connectable to the computing apparatus via an I/O interface such as a USB port; and

program instructions directly entered by the user using the keyboard 56b.

FIG. 3 shows the computing apparatus as having been programmed so that the memory 51 contains a service discovery manager module 51a for implementing the service discovery manager 15, plug-in modules 51b for implementing the plug-ins 16, an operations controller module 51c for implementing the operations controller 11, a task manager module 51d for implementing the task manager 14 and, a service publisher module 51e for implementing the service publisher 13.

It will be appreciated the client devices 20 will, being processor controlled machines, also have a processor with associated memory, I/O interfaces and some form of user interface device(s) which, in the case of a personal computer, will be similar to that shown in FIG. 3 and in the case of a digital camera will be more limited generally consisting of a small display and a user control that enables selection of items from a displayed menu.

The manner in which a controller 10 enables the carrying out of a task based on a number of services will now be described.

A task consists of one or more services, depending upon the particular task. Common tasks or tasks that have been or are likely to frequently used may be stored by the task manager 14. Other tasks may be assembled by the task manager 14 from available services in accordance with input information received from the user.

In order for a task to be carried out it has, of course, first to be initiated by a user. In order to facilitate this, a client device 20 may be provided with a basic task user interface that prompts the user with a question such as:

What do you want to do?

and may present the user with a number of options defining currently available tasks. The nature of the tasks available will generally depend upon the particular client device. As an example, if the client device is a networked photocopier, then task options may include:

Scan

Scan and email

Scan, OCR and email

As another possibility, the basic task user interface may enable the user to define a task by selecting options from a displayed menu, for example if the user wishes to scan a hard copy document and email it in editable form the user may select displayed options “scan”, “optical character recognition”, and “email” from a menu.

FIG. 4 is a flowchart illustrating steps carried out by the task manager.

As set out above, the controller 10 stores the description for discovered services. At S1 in FIG. 4, the task manager 14 determines from the available discovered services, the client device and the user which tasks are available to that client device and user.

Then, at S2, the task manager causes the client device 20 to present the user with a list of tasks/options available to that user, one example of an available task may be “scan a hard copy document, perform optical character recognition and then email the document in an editable form”.

When, at S3, the user selects a task from the list presented to him at the client device then, at S4, the task manager identifies a first service required by the task by checking the type components of the stored service descriptions to determine which of the type components match the tasks requirements and, of those, which services have input, output, capability and classification parameters acceptable for the task.

It is possible that more than one service may match the requirement. If so, then at S4, the task manager selects one of those matching services in accordance with predetermined criteria as will be described below.

Once a service has been selected for the first procedure or step of the task then, at S5, the task manager 14 determines whether user input is required and, if so, causes the client device to present the appropriate user interface to the user to get the required user input at S6.

If the answer at S5 is no or if user input has already been obtained at step S6 then, at S7, the task manager requests the operations controller 11 to cause the required service to be run.

Then, at S8, the task manager checks to see whether the task has been completed, that is whether the task involves a further procedure that requires another service.

If the task manager determines that the task involves a further procedure that requires another service then steps S4 to S7 are repeated and at S8 the task manager again checks whether there are further procedures that require services to be run in order for the task to be completed. The procedure ends once the task manager determines at S8 that there are no further procedures requiring services to be run.

FIG. 5 shows steps carried out when a service is discovered.

When the operations controller 11 starts the service discoverer 12 it registers a Discovery Listener with the service discovery manager 15. When the service discoverer 12 locates a plug-in 16, it starts the plug-in 16 and then registers the service discovery manager 15 with the plug-in 16 When a service 30,31,32 is discovered by a plug-in 16, the plug-in 16 notifies the service discovery manager is which notifies the operations controller 11.

Upon discovery of a new service then, at S11 in FIG. 5, the operations controller 11 receives the service description, updates route information associated with the service description (for example by adding its controller network address to route address and by adding one to a hop count, where a “hop” is a step or passage from one controller to the next on the network) and, having stored the service description with its associated route information in its service cache 17, passes the service description with its associated route information to the service publisher 13 for storage in the services list 18. As another possibility, the hop count may be updated by the service publisher 13.

Because the service publisher 13 of each controller 10 republishes (that is makes accessible to other controllers on the network N) discovered services by using or implementing the common API 19, the same service may be discovered by a controller 10 via a number of different routes. In the event that a service is discovered more than once, then the service description is still added to the service cache 17 step S12 so that, if a subsequent request to run that service fails, the operations controller 11 can try and access the service via the other route or one of the other routes.

FIG. 6 shows a flowchart for illustrating operations carried out by the operations controller 11 when the task manager 14 issues a request for a service to be run at S20. Thus, at S21, the operations controller 11 implements the run service method of the service description of the selected service at S21 to cause the service to be run. If the service is not a local service, then the controller 10 causes the request for the service to be run to be passed on to the controller from which the service was discovered and, if that controller is not the controller that actually runs that particular service, that controller will, in turn, pass the request for the service to be run on to the controller from which it discovered the service and so on until the request for the service to be run reaches the controller that actually runs that particular service. The controller that actually runs that particular service will then invoke the service and return the results to the requesting controller 10.

If, at S22, the request for a service to run fails, for example because one or more of the network addresses along the route path is inoperable or the service is currently busy, then at S23, the operations controller 11 determines whether there is another route for the same service and, if so, selects that other route at S24 and repeats steps S21 to S23.

If the answer at S23 is no, that is the service has failed and there is no other route that has not yet been explored, then at S25, the operations controller checks whether there is another acceptable service and, if so, selects that other service at stop S26 and repeats steps S21 to S26.

Where more than one service is available for carrying out a particular procedure, then as set out at S4 in FIG. 4, one of the services may be selected on the basis of predetermined criteria. These criteria may include at least one of:
1. the number of hops required to reach the controller that runs the service, on the grounds that this may determine the reliability of the service and the time taken to access the service;
2. a rating system;
3. required processing time;
4. current status of the service;
5. costs;
6. quality;
7. recommendations from users on the system.

One or more of the above preferences may be determined by information input by the user via an appropriate user interface.

In addition to the above, dependent upon the client device or devices 20 that the controller 10 services, the controller 10 may be specialised so that it filters through only particular services. This may be achieved by selection of the plug-ins so that only services complying with particular protocols are discovered or may be achieved by the operations controller 11 filtering through only services whose service descriptions match certain requirements. For example where the client device is a digital camera, then the controller 10 may be configured to filter through only services that are applicable to a digital camera so excluding, for example, word processing services.

The operations controller 11 may also have security settings that determine whether or not a service will be passed on to a requesting controller. FIG. 7 shows a flowchart illustrating one way in which this may be implemented. Thus, when at S30, a controller 10 receives a service discovery request, that request will be accompanied by data that identifies the requesting controller and may also identify the requesting user.

At S31, the operations controller 11 determines whether the security rating for the requesting controller or task manager and/or user enables them to have access to the requested service and, if not, advises the requesting service discoverer 12 that the service is not available.

An operations controller 11 may have different security ratings for local and remote users.

In the event that the operations controller 11 determines that the requesting controller and/or user has/have an appropriate security rating, then at S33, the operations controller checks whether the service is a republished service and, if not, causes the service to be run at S34. If, however, the service is a republished service then at S35, the operations controller passes the request for the service on to the controller from which the service was discovered. That controller then repeats the procedure shown in FIG. 7 so that the request is passed from controller to controller until it reaches the controller that runs the requested service.

As shown in FIG. 7, the controller is arranged to check the security rating before determining whether or not a service is a republished service. This enables each controller to have its own security ratings for remote services. As another possibility, steps S33 and S31 may be reversed so that the operations controller 11 first checks whether the service is a republished service and, if so, passes the request onto the controller from which the service was discovered without checking the security ratings. This would mean that whether or not a particular controller and/or user is given access to a service will be determined solely by the controller that initially discovered that service.

FIG. 4 illustrates one way of carrying out a task. FIG. 8 illustrates another way in which a task may be carried out once the user has selected a task or has indicated what they require of the task for example scan a hard copy document, perform optical character recognition and then email the document in an editable form.

As set out above, the controller 10 stores the descriptions for discovered services.

At S40 in FIG. 8 the task manager 14 requests the operations controller 11 to identify from the description stored in the service cache 17 a service or services matching the requirements for a first procedure or step of the task.

The task manager 11 then checks the type components of the stored service descriptions to determine if any of the type components match the task manager's requirements and, if so, determines whether the input, output, capability and classification parameters in that service description are acceptable for the task in hand.

If, at S41, the operations controller 11 reports that no appropriate services have been identified, then at S42, the task manager 14 requests the operations controller 11 to instruct the service discovered 12 to locate a service.

Moe than one service may match the task requirements. Accordingly, at S43, the task manager 14 determines whether more than one service has been identified and, if so, selects on of the services on the basis of predetermined criteria as will be discussed below.

Once a service has been selected for the first procedure or step of the task then, at S44, the task manager 14 determines whether the task involves a further procedure that requires another service and, if the answer is yes, repeats steps S40 to S43.

Once services have been discovered for all of the procedures required to complete the task then at S45 the task manager 14 determines the next action or procedure required by the task and requests the operations controller 11 to act accordingly. Thus, if the task manager determines at S45 that user input is required and that this does not include a new user interface then the task manager requests the operations controller to communicate with the client device 20 to prompt the user to input the necessary data. Otherwise the task manager determines the next action required is for a service to be run, then the task manager requests the operations controller 11 to cause the required service to be run. The required service may in some cases include a sub-service such as a user interface service and in those cases the operations controller 11 will first download the required user interface to the client device 20.

Step S45 is repeated until the task manager determines at S46 that the task has been completed, that is all of the services required to complete the task have been run.

As described above, each of the controllers republishes discovered services using or implementing the common API so that, as far as other controllers are concerned, each controller also looks like a service. The services available may include input services, output services, processing services and user interface services. The provision of user interfaces as services means that the user interface can be loaded onto the client device and run as and when required so that dedicated user input services can be provided for particular services and, in addition, the user interface for a particular client device may be easily updated and/or modified.

As described above, a service may include default parameters for the operation provided by this service. For example, where the service is a scanning service, then a default scanning resolution may be defined. Similarly, where the service is a printing service, then a default printing characteristic such as black and white, one-sided and so on may be defined. In some tasks, specific parameters may be required of a service. Thus, for example, in the case of a task to scan and then email in editable form a hard copy document, the optical character recognition software may require a scanning resolution higher than the normal default scanning resolution of the scanning services. In order to cope with such occurrences, the task manager 14 may be configured Lo provide the task itself with one or more default parameters and the task may be configured such that the task default parameters override service parameters. Taking as an example, the task mentioned above, this would enable the task manager 14 to define for the task a default scanning resolution parameter higher than the default resolution scanning parameter of the scanning service In contrast, where the task to scan and email a photograph the task manager 14 may define a low resolution scanning parameter that overrides the scanning services default parameter so that an image file that is not too large, that is appropriate for emailing, is produced by the scanning service. In addition, a user interface service for a task or a service within a task may enable a user to change or customize the service level default parameter or the task level default parameter in accordance with the particular users requirements.

As so far described above, once a task has been defined and the necessary services assembled, the operations controller 11 and the task manager 14 of the controller 10 at which the task originated coordinate carrying out of the task with the services required by the task being run by the controllers which initially discovered those services.

This may, however not necessarily always be convenient for a user, whose local controller may change as he moves to different physical locations serviced by the network. In addition, certain client devices may be more convenient when carrying out certain services within a task. Thus, for example, in the case of the above task to scan and email in editable form a hard copy document, the user may wish to use a networked photocopier to perform the scanning because this is quick than using a scanner attached to a personal computer but may then wish to move to a personal computer to enable access to a keyboard to enter an email message. In addition, some services may require more processing power than other services and it may speed up completion of a task if a high processing power service is completed by a device having a lot of processing capacity, for example it may be more efficient for a particular service to be carried out by a networked personal computer rather than a networked digital camera, where both of those devices run the same or a similar service.

In an embodiment, the task manager 14 is configured to provide a task so that the task can be stored in an incomplete form and transferred to another, for example more powerful, controller to enable completion of the next part of a task.

In an embodiment, the task manager 14 stores the current state of a task and the data associated in a context which can be passed between controllers allowing a user to access the task from different client devices. This means that a user can commence a task at one client device and then move to another that may be more suitable for continuation of the task with, in each case, the controller local to the user's current client device controlling the coordination and processing of a task so as to enable the task data to be stored for later retrieval or passed to another controller for continued processing.

In an embodiment, the services and tasks are defined using XML (Extensible Mark-up Language) and the task is stored in a context enabling parts of the task to be passed between controllers.

Appendix 1 illustrates an example of a service description for a web gallery service which creates a web gallery from a series of images. The ellipsis indicate omitted data. As can be seen from Appendix 1, the name of the service is “web gallery” and the service is of the type “synthesize”. This service description defines a required input, a number of outputs and a number of parameters. As can be seen, the input has an ID “image” and must be of a type MIME in the JPEG format while an output of ID “HTML” must be of type MIME in the HTML format and the output of ID “fullimage” and “thumbimage” must be of type MIME and in the JPEG format. The parameters in this example are title, thumbs per row, thumb width, thumb height, web file name, web images directory and web thumb prefix all of type “simple” with the title, web file name, web images directory and web thumb prefix being of “string” format and the remaining parameters being of “int” or integer format.

Appendix 2 illustrates an example of a task description. In this example, the purpose of the task is to scan a document and send it via email and the task name is “Send OCR”. As can be seen from Appendix 2, the task consists of address book, scanner, PDF conversion, email and OCR services with the respective service IDs “address”, “service 2”, “convert”, “service 0” and “service 1”. In addition, the task includes a user interface service of name “OCR email UI” that is to be downloaded to the client device when the services of ID “service 0”, “service 1” and “convert” are being run.

When this task is implemented by a task manager, the task manager 14 first requests the operations controller 11 to cause the address book user interface service to be run to cause the address book user interface to be downloaded the client device to enable the user to select the name and address of the intended recipient of the email. Once the name and address of the intended recipient have been selected or entered by the user, then the task manager 14 requests the operation controller 11 to cause the scanner service to run. The scanner service enables a hard copy document placed on a scanner by the user to be scanned at a default resolution, in this example 300 DPI, and to provide output data with an ID “image” for input into the “convert” service. The scanner service does not require a user interface to run as the parameters required for the scanning, e.g. scan resolution are supplied by the task defaults. Once the task manager determines that the scanner service has provided the output data, then the task manager 14 requests the operations controller 11 to cause the user interface service “OCR Email UI” to be run and downloaded to the client device to enable input of the data required from the Baser for the remaining services. Once the task manager 14 has determined that the user has input the necessary information, in this case whether the user wants to send an OCRed version of the document to the email recipient, and/or send it in a PDF file which has been converted from the image, then the task manager 14 requests the operations controller 11 to run either the “convert” service, or the “OCR” service, or both. Once the task manager 14 determines that the “convert” and “OCR” services have completed their operations, if required, then the task manager 14 requests the operations controller 11 to cause the email service to run so as to enable the document to be emailed to the intended recipient.

As will be appreciated from Appendix 2 the operations controller 11 and task manager 14 coordinate carrying out of the task so that each service is called as and when required and provides output data for a target service with a given target service ID and target input ID.

The service discoverer 12 may discover services only upon instruction by the operations controller. As another possibility, the service discoverer 12 may be configured to check continually for new services on the system and to alert the operations controller 11 whenever new services are discovered. This would have the advantage that all services discoverable on the network would be immediately available to the task manager. However, where the network provides a large number of services, then this would require significant memory capacity to retain the descriptions of all of these services and may not be desirable where the controller has limited resources. Of course, one or more of the controllers on the network may be configured to discover services only upon request while one or more others of the controllers on the network may be configured continually to discover services, dependent upon the capabilities and requirements of the controllers.

In the described example, the user interfaces with the system via a single client device. As set out above, it may in some circumstances be desirable for the task to be portable within the network system. This may be achieved by storing the task in a data structure known as a context, for example an XML-based context which can be transferred to another controller or client device that may even use a different operating system and language without the requirement for translation of the context.

Thus, although not shown in Appendix 2, the task manager 14 may configure the task so as to enable the history of the task and the data associated with the current status of the task to be stored in an XMT, context so that once a service has run, the task may be stored with the data resulting from the running of that service so that it can, if required by the user, then be transferred to another controller or client device that can control the carrying out of the next service.

In the embodiments described above, the service discoverer uses a plug-in architecture. Although this has advantages for the reasons set out above, the service discoverer 12 may also be implemented as a dedicated service discoverer capable of discovering only services operating with certain protocols. Similarly, in the embodiments described above, the task manager is implemented as a module which can be replaced or upgraded as required. Although this has advantages as set out above, it should also be possible to integrate the task manager within the operations controller, although this would make upgrading or replacing of the task manager more difficult.

| | APPENDIX 1 |
|---|---|
| | EXAMPLE SERVICE DESCRIPTION |
| | <?xml version=“1.0” encoding=“UTF-8” ?> |
| − | <CIAServiceGroup> |
| − | <CIAService name=“WebGalleryService” type=“Synthesize” |

GUID=“4f1d0d:fbee5bda43:-7ff2”>
<URI>class:WebGalleryService.jar:com.canon.cre.cia.services.webgall
ery.WebGalleryService</URI>

| − | <Description> |
|---|---|
| | <Icon type=“mime” format=“image/png”>iVBOR... QmCC</Icon> |
| | <Info lang=“en” name=“Web Gallery”>This Service creates a web gallery |

from a series of images</Info>

<Info lang=“fr”

name=“Galerie Web”>Ce service crée un galerie web d'une serie

d'images</Info>

</Description>

| − | <Inputs> |
|---|---|
| | <Input id=“image” type=“mime” format=“image/jpeg” multiple=“true” |

required=“true” />
</Inputs>

| − | <Outputs> |
|---|---|
| | <Output id=“html” type=“mime” format=“text/html” multiple=“true” /> |
| | <Output id=“fullImage” type=“mime” format=“image/jpeg” multiple=“true” |

/>

<Output id=“thumbImage” type=“mime” format=“image/jpeg”

multiple=“true” />
</Outputs>

| − | <Parameters> |
|---|---|
| | <Parameter id=“title” type= “simple” format= “string” /> |
| | <Parameter id=“thumbsPerRow” type= “simple” format=“int” /> |
| | <Parameter id=“thumbWidth” type=“simple” format=“int” /> |
| | <Parameter id=“thumbHeight” type=“simple” format=“int” /> |
| | <Parameter id=“webFileName” type=“simple” format=“string” /> |
| | <Parameter id=“webImagesDirectory” type=“simple” format=“string” /> |
| | <Parameter id=“webThumbPrefix” type=“simple” format=“string” /> |

</Parameters>
</CIAService>

| | |
|---|---|
| − | <CIAUIService name=“WebGalleryUI” type=“SynthesizeUI” |

GUID=“4f1d0d:fbee5bda43:-7ff1”>

<Service name=“WebGalleryService” />
<UILanguage name=“java” />

</CIAUIService>
</CIAServiceGroup>

| | APPENDIX 2 |
|---|---|
| | EXAMPLE TASK DESCRIPTION |
| | <?xml version=“1.0” encoding=“UTF-8” ?> |
| − | <!-- |

UTF-8 Chars: | ∥ |

[symbol]

-->

| − | <CIATask name=“SendOCR”> |
|---|---|
| | <Device name=“iR” /> |
| | <Output uri=“address” id=“address” type=“simple” format=“string” /> |
| − | <Description> |
| | <Info lang=“en” name=“AddressBook” /> |

</Description>

| − | <Description id=“email”> |
|---|---|
| | <Icon uri=“scan.png” /> |
| | <Info lang=“en” name=“Scanned Document”>Scan a document and sends |

via email</Info>

<Info lang=“fr”

name=“Email le document”>Scanner un document et envoyer par email</Info>
</Description>

| − | <Description id=“scan”> |
|---|---|
| | <Icon uri=“email.png” /> |
| | <Info lang=“en” name=“Email Document”>Scan a document and sends via |

email</Info>

<Info lang=“fr” name=“Email le document”>Scanner un document et envoyer

par email</Info>
</Description>

| − | <Service id=“address” name=“OpenAddressBook” type=“ContactOutput”> |
|---|---|
| | <Output id = “address” required=“true” multiple=“true” |

targetServiceID=“service0” targetInputID=“address” />
</Service>

| − | <Service id=“service2” name=“ScannerService” type=“Scanner”> |
|---|---|
| | <Parameter id=“resolution” type=“simple” format=“int”>300</Parameter> |
| | <Output id=“image” required=“true” multiple=“true” |

targetServiceID=“convert” targetInputID=“InputData” />

<Output id=“image” required=“true” multiple=“true”

targetServiceID=“service1” targetInputID=“image” />
</Service>

| − | <Service id=“convert” name=“ConvertToPDFService” type=“Convert”> |
|---|---|
| | <Input id=“inputData” required=“true” multiple= “false” /> |
| | <Output id=“outputOata” required=“true” multiple=“true” |

targetServiceID=“service0” targetInputID=“attachments” />
</Service>

| − | <Service id=“service0” name=“EmailService” type=“Email”> |
|---|---|
| | <Parameter id=“subject” type=“simple“ format=“string”>Document from |

%fullname%</Parameter>

<Input id=“subject” required=“false” multiple=“false” />
<Input id=“body” required=“false” multiple=“false” />
<Input id=“address” required=“true” multiple=“true” />
<Input id=“attachments” required=“false” multiple=“true” />

</Service>

| − | <Service id=“service1” name=“OcrService” type=“Ocr”> |
|---|---|
| | <Input id=“image” required=“true” multiple=“true” /> |
| | <Output id=“text” required=“true” multiple=“true” |

targetServiceID=“service0” targetInputID=“body” />
</Service>

| − | <UI name=“OCREmailUI”> |
|---|---|
| | <Service id=“service0” /> |
| | <Service id=“service1” /> |
| | <Service id=“convert” /> |

</UI>

| − | <UI name=“AddressBookUI”> |
|---|---|
| | <Service id=“address” /> |

</UI>

</CIATask>

1. Apparatus connectable to a network for enabling the carrying out of task for a user, the apparatus comprising:
a service discoverer operable to discover services at locations on the network;
a task manager operable to control the carrying out of tasks using services discovered by the service discoverer;
an operations controller operable to control operations related to services; and
a service publisher operable, as a result of a discovery of a service by the service discoverer, to make that service discoverable by other apparatus connected to the network.

2. Apparatus according to claim 1, wherein the operations controller is operable to receive requests for the running of services, to determine whether the requested service is a service local to the apparatus that the operations controller can run and, if not, to pass the request for the running of the service onto the location on the network at which the service discoverer discovered the service.

3. Apparatus according to claim 2, wherein the operations controller is configured to receive requests for the running of services from the task manager and from other apparatus connected to the network.

4. Apparatus according to claim 2, wherein the operations controller is operable to determine whether or not a request for a service to be run can be executed or passed onto to the location on the network at which the service discoverer discovered the service in accordance with at least one security rating associated with the at least one of the user and the requesting apparatus or task manager.

5. Apparatus according to claim 4, wherein the operations controller is configured to use different security ratings for requests from the task manager and requests from other apparatus for a service to be run.

6. Apparatus according to claim 4, wherein the operations controller is configured to implement different security restrictions depending upon whether the user is local to the apparatus or whether a service is being requested by another apparatus.

7. Apparatus according to claim 1, wherein the service publisher is configured to store a list of service descriptions each defining a function or functions implemented by the corresponding service.

8. Apparatus according to claim 1, wherein the operations controller is configured to receive and store for services discovered by the service discoverer service descriptions with each service description defining a function or functions implemented by the corresponding service.

9. Apparatus according to claim 7, wherein the service publisher is configured to store a list of the service descriptions discovered by the service discoverer.

10. Apparatus according to claim 7, wherein each stored service description includes at least a service name, a description of the function of the service, and input, output and parameter data required by the service.

11. Apparatus according to claim 1, wherein the task manager is operable to select a service from a number of different discovered services that can perform the same function on the basis of predetermined criteria.

12. Apparatus according to claim 1, wherein the task manager is operable to select a service from a number of different discovered services that can perform the same function on the basis of at least one of the following criteria: an indication of the location on the network of the service; a rating system; a required processing time; a current status of the services; a service running cost; a service quality; and a user recommendation.

13. Apparatus according to claim 1, wherein, in the event that the same service is discovered more than once by the service discoverer by different routes over the network, the operations controller is operable to store information related to each of the routes to the service to enable the operations controller to access the service by a different route.

14. Apparatus according to claim 13, wherein the operations controller is operable to select another route to a service in the event that the same service is discovered more than once by the service discoverer by different routes over the network and a request via one of the routes to run the service fails.

15. Apparatus according to claim 1, wherein, upon discovery of a service, the apparatus is operable to increment a hop count associated with that service and indicating the number of steps from one apparatus to another over the network to the location of the service.

16. Apparatus according to claim 7, wherein, upon discovery of a service, the apparatus is operable to increment a hop count indicating the number of steps from one apparatus to another over the network to the location of the service, wherein the service descriptions are associated with route information that indicates the route taken over the network from the service location to the apparatus and wherein the event that the service discoverer discovers a service more than once, the operations controller is operable to select a route on the basis of the associated hop count.

17. Apparatus according to claim 1, wherein the service discoverer has a plug-in architecture and comprises a service discovery manager and a number of service discovery plug-in modules with different service discovery plug-in modules being arranged to discover services that use different protocols.

18. Apparatus according to claim 17, wherein one service discovery plug-in module is configured to discover Web services, another service discovery plug-in module is configured to discover JINI services and another service discovery plug-in module is configured to discover local services.

19. Apparatus according to claim 1, wherein the task manager is configured to provide a task so that the task can be stored in an incomplete form and transferred to another apparatus.

20. Apparatus according to claim 19, wherein the task manager is configured to store a current state of a task and data associated with the task in a context, for example an XML context, which can be passed between apparatus.

21. Apparatus according to claim 1, wherein the operation controller 11 is operable to filter out services that cannot be used by a client device or client devices coupled to the apparatus.

22. Apparatus according to claim 1, in combination with at least one client device via which a user can interface with the apparatus.

23. Apparatus according to claim 1, in combination with storage means storing at least one service.

24. A network system apparatus comprising a plurality of apparatus in accordance with claim 1, at least one client device associated with each apparatus, and a plurality of service storage means storing services, at least some of the apparatus being directly connectable to the network and at least one apparatus being connectable to the network via another apparatus and at least some of the service storage means being connected to the network only via an apparatus in accordance with claim 1.

25. Apparatus according to claim 1, wherein the services have a common application programming interface.

26. Apparatus according to claim 23, wherein the services include input services, output services, and processing services.

27. Apparatus according to claim 23, wherein the services include input services, output services, processing services and user interface services.

28. Apparatus according to claim 23, wherein at least some services have subsidiary services.

29. Apparatus according to claim 23, wherein at least some services have default values for parameters and the task manager is configured to enable a default value to be provided for a task that overrides a service default value.

30. Apparatus according to claim 27, wherein at least one of some services and some tasks have default values for at least one parameter and at least one user interface service is configured to enable a user to specify a value for a parameter that overrides the default value.

31. A method of enabling the carrying out of task for a user, the method comprising apparatus carrying out the steps of:
discovering services at locations on the network;
controlling the carrying out of tasks using discovered services; and
as a result of the said discovery making discovered services discoverable by other apparatus connected to the network.

32. A method according to claim 31, further comprising the apparatus carrying out the steps of receiving requests for the running of services, determining whether the requested service is a service local to the apparatus that can be run and, if not, passing the request for the running of the service onto the location on the network at which the service was discovered.

33. A method according to claim 31 wherein requests for the running of services are received from a task manager of the apparatus and from other apparatus connected to the network.

34. A method according to claim 32, further comprising the apparatus carrying out the steps of determining, in accordance with at least one security rating associated with the at least one of the user and the requesting apparatus or task manager, whether or not a request for a service to be run can be executed or passed onto to the location on the network at which the service was discovered.

35. A method according to claim 34, wherein different security ratings are used for requests from a task manager of the apparatus and requests from other apparatus for a service to be run.

36. A method according to claim 34, wherein different security restrictions are implemented depending upon whether the user is local to the apparatus or whether a service is being requested by another apparatus.

37. A method according to claim 31, further comprising the apparatus storing a list of service descriptions each defining a function or functions implemented by the corresponding service.

38. A method according to claim 31, further comprising the apparatus receiving and storing for discovered services service descriptions with each service description defining a function or functions implemented by the corresponding service.

39. A method according to claims 37, wherein each stored service description includes at least a service name, a description of the function of the service, and input, output and parameter data required by the service.

40. A method according to claim 31, wherein the apparatus selects a service from a number of different discovered services that can perform the same function on the basis of predetermined criteria.

41. A method according to claim 31, wherein the apparatus selects a service from a number of different discovered services that can perform the same function on the basis of at least one of the following criteria: an indication of the location on the network of the service; a rating system; a required processing time; a current status of the services; a service running cost; a service quality; and a user recommendation.

42. A method according to claim 31, wherein, in the event that the same service is discovered more than once by different routes over the network, the apparatus stores information related to each of the routes to the service to enable the service to be accessed by a different route.

43. A method according to claim 42, wherein the apparatus selects another route to a service in the event that the same service is discovered more than once by different routes over the network and a request via one of the routes to run the service fails.

44. A method according to claim 31, wherein, upon discovery of a service, the apparatus increments a hop count indicating the number of steps from one apparatus to another over the network to the location of the service.

45. A method according to claim 37, wherein, upon discovery of a service, the apparatus increments a hop count indicating the number of steps from one apparatus to another over the network to the location of the service, wherein the service descriptions are associated with route information that indicates the route taken over the network from the service location to the apparatus and wherein, in the event that a service is discovered more than once, the apparatus selects a route on the basis of the associated hop count.

46. A method according to claim 31, wherein the apparatus uses plug-in service discovery architecture and different service discovery plug-in modules discover services that use different protocols.

47. A method according to claim 46, wherein one service discovery plug-in module discovers Web services, another service discovery plug-in module discovers JINI services and another service discovery plug-in module discovers local services.

48. A method according to claim 31, wherein the apparatus configures a task so that the task can be stored in an incomplete form and transferred to another apparatus.

49. A method according to claim 48, wherein the apparatus stores a current state of a task and data associated with the task in a context, for example an XML context, which can be passed between apparatus.

50. A method according to claim 31, wherein the services have a common application programming interface (API).

51. A method according to claim 31, wherein the services include input services, output services, and processing services.

52. A method according to claim 31, wherein the services include input services, output services, processing services and user interface services.

53. A method according to claim 31, wherein at least some services have subsidiary services.

54. A method according to claim 31, wherein at least some services have default values for parameters and the apparatus enables a default value to be provided for a task that overrides a service default value.

55. A method according to claim 52, wherein at least one of some services and some tasks have default values for at least one parameter and at least one user interface service enables a user to specify a value for a parameter that overrides the default value.

56. A method according to claim 31, further comprising the apparatus filtering out services that cannot be used by a client device or client devices coupled to the controller.

57. A computer program product comprising program instructions for programming a processor to carry out a method in accordance with claim 31.

58. A storage medium storing program instructions for programming a processor to carry out a method in accordance with claim 31.

59. Apparatus according to claim 1, wherein the service discoverer is arranged to discover services that use different protocols, and has a plug-in architecture.

60. Apparatus according to claim 1, wherein the service discoverer comprises service discoverer modules and a service discovery manager operable to manage said service discoverer modules.

61. Apparatus according to claim 60, wherein each service discoverer module is arranged to discover services using a different protocol.

62. Apparatus connectable to a network for enabling the carrying out of task for a user, the apparatus comprising:
service discoverer means for discovering services at locations on the network;
task managing means for controlling the carrying out of tasks using services discovered by the service discoverer means;
operations controlling means for controlling operations related to services; and
service publishing means for, as a result of a discovery of a service by the service discoverer, making that service discoverable by other apparatus connected to the network.
